(19) United States
(12) Patent Application Publication
(10) Pub. No.: US 2007/0074956 A1
(43) Pub. Date: Apr. 5, 2007

(54) Rotary pull switch

(76) Inventors: Joachim Koehler, Biebelsheim (DE); Peter Leng, Mainz (DE); Klaus Schnell, Appenheim (DE)

Correspondence Address: DELPHI TECHNOLOGIES, INC., M/C 480-410-202, PO BOX 5052, TROY, MI, 48007, US

(21) Appl. No.: 11/528,869

(22) Filed: Sep. 28, 2006

(30) Foreign Application Priority Data
Oct. 1, 2005 (EP) 05021560.7

(51) Int. Cl. H01H 9/00

(52) U.S. Cl. 200/4

(57) ABSTRACT

A rotary/pull switch , in particular a light switch for a motor vehicle, includes an actuating element having a base and axle that is guided in a housing. A permanent magnet is associated with the axle and several magnetic field sensors are associated with the base for determining the switching positions of the actuating element.

### TECHNICAL FIELD

The invention relates to a rotary/pull switch, in particular a light switch, for a motor vehicle, with an actuating element having an axle which is guided in a housing, and with a base.

### BACKGROUND

DE 199 29 200 A1 discloses a rotary selector switch system which includes a rotatably mounted shaft and a permanent magnet which is rotatable relative to a magnetoresistive sensor upon movement of the shaft. The rotary movement of the shaft is transmitted to a rotatably mounted element, in which is embedded the permanent magnet, and which is mounted rotatably within range of the magnetoresistive sensor. The axis of rotation of the shaft differs from the axis of rotation of the permanent magnet.

Furthermore, DE 199 53 204 A1 shows a switching module for switching control current paths, in particular in vehicles, with a switching module housing, with an actuating unit that can be actuated in particular by a human being, and with a switching member that is operatively connected to the actuating unit and that switches the control current path. The actuating unit acts upon a switching arm arranged in the switching module housing from a defined switching position without leaving the switching arm in an intermediate position into another defined switching position. On the switching arm is arranged the switching member that switches the control current path contactlessly. The control current path comprises a magnetic field sensor, in particular a Hall element, and the switching element comprises a magnet that can be guided into the detection range of the magnetic field sensor.

Furthermore, DE 43 19 543 A1 shows a motor vehicle light switch with a rotary/pull switch housed in a housing for the parking and driving lights and the interior lighting. This motor vehicle light switch comprises several mechanical switching members with contact elements for acting on terminal contacts and is disadvantageous insofar as it is relatively elaborate to manufacture and therefore expensively designed.

Accordingly, the inventors have recognized a need for a rotary/pull switch of the kind mentioned hereinbefore, that, with a reliable manner of operation, comprises a low-wear and inexpensive construction.

### SUMMARY OF THE INVENTION

According to the invention, the object is achieved by associating a permanent magnet with the axle and associating a plurality of non-rotatably mounted magnetic field sensors with the base so as to enable determination of the switching positions of the actuating element.

On account of these measures, there is provided a rotary/pull switch which contactlessly detects the different switching positions of the actuating element and which, with a cheap construction, is subjected to little wear. The magnetic field sensors detect both a change in direction of rotation and an axial change of position of the permanent magnet on account of a corresponding action of the actuating element, and cause corresponding switching operations.

In order that the permanent magnet is located directly within detection range of the magnetic field sensors, appropriately the permanent magnet is arranged on the end of the axle facing towards the base.

In an exemplary embodiment, the magnetic field sensors are designed as two Hall sensors offset from each other by 90°. Accordingly, on rotation of the permanent magnet and hence of its magnetic field from one pole to the other pole a sine-like or cosine-like signal shape of the current is detected. Due to a pull/push action, that is, an axial displacement of the permanent magnet, the amplitude of the signal shape varies. On account of the signal shape which can be defined unambiguously, evaluation with respect to the position of the actuating element is ensured.

In an exemplary embodiment, a control device is coupled by a bus system to the Hall sensors for evaluation of the detected signals. The control device can be associated directly with the rotary/pull switch or be a control device already existing in a motor vehicle, and includes at least one computer module for evaluation of the signals of the Hall sensors and for the control of associated switching operations.

In an exemplary embodiment, the bus system is a LIN bus. The local interconnect network (LIN) may be specially developed for cheap communication of intelligent sensors and actuators in motor vehicles and may be used wherever the bandwidth and versatility of CAN (controller area network) are not needed.

In an exemplary embodiment, the base is manufactured by MID technology and includes the Hall sensors. The base manufactured by MID technology (moulded interconnected devices) may for example include integrated circuits and comprise further electronic assemblies. Accordingly, the Hall sensors may be integrated with the base to form an assembly of moulded interconnected devices.

In an alternative embodiment, the Hall sensors may be associated with a printed circuit board within the housing. The printed circuit board connects further electrical and/or electronic components both to each other and to an electrical system of a motor vehicle.

In an exemplary embodiment, so as to fix the actuating element in defined switching positions, latch elements are arranged between the axle and the housing for positioning the pull and rotary switching positions of the actuating element. Appropriately, at least one optical fibre may be arranged within the housing, the optical fibre being associated with a light source for backlighting symbols on the housing side.

It should be appreciated that the characteristics mentioned above and yet to be explained below can be used not only in the combination provided, but also in other combinations. The framework of the present invention is defined only by the claims.

### BRIEF DESCRIPTION OF THE DRAWINGS

The invention is described in more detail below with the aid of a practical example with reference to the associated drawings. They show:

FIG. 1 a perspective view of an exemplary embodiment of a rotary/pull switch according to the invention,

FIG. 2 a sectional view of an exemplary embodiment of a rotary/pull switch according to the invention and

FIG. 3 a perspective partial view of an exemplary embodiment of a rotary/pull switch according to the invention.

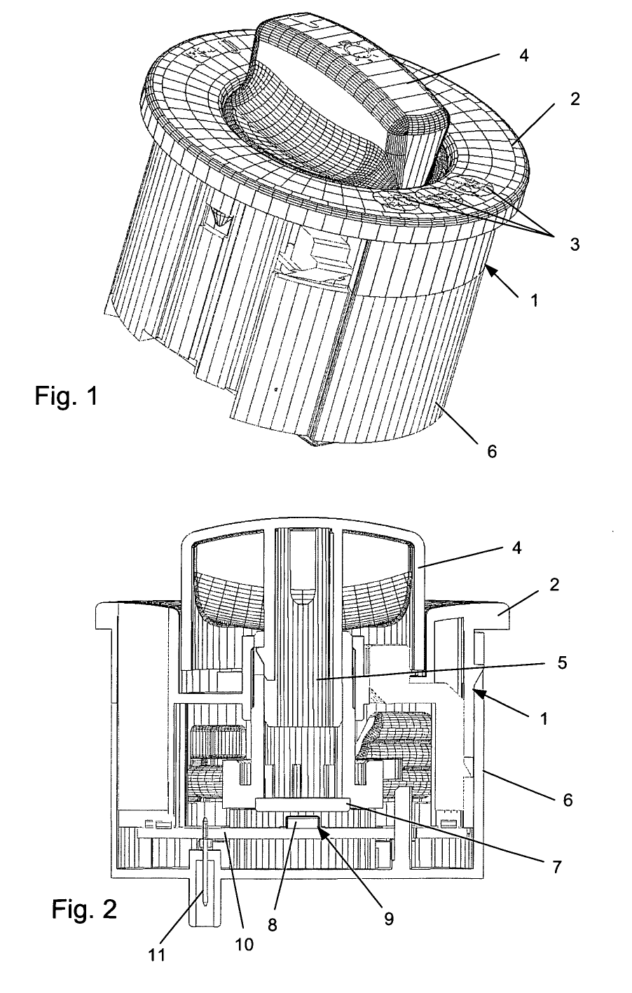

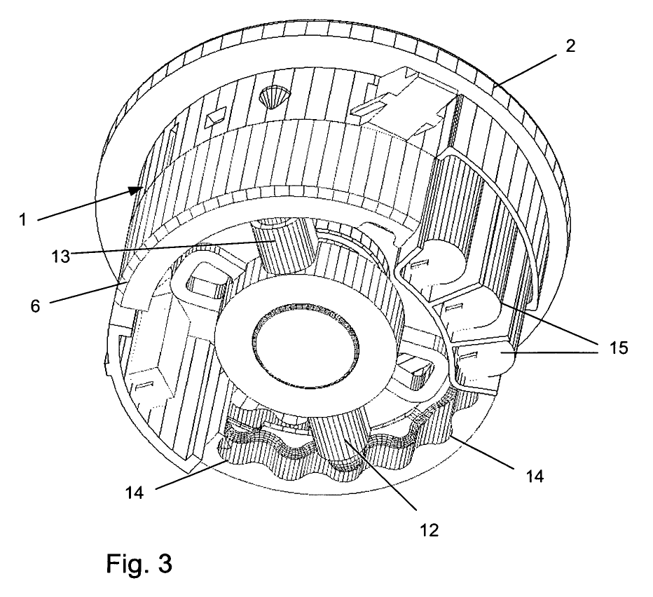

### DESCRIPTION OF EXEMPLARY EMBODIMENTS

In an exemplary embodiment, a rotary/pull switch includes a housing 1 with a cover 2 at the top that comprises several backlightable symbols 3, and through which extends an actuating element 4 that, on its lower side, is provided with an axle 5 mounted rotatably and axially displaceably in the housing 1. At the free end of the axle 5, facing in the direction of a base 6, is arranged a permanent magnet 7 that co-operates with two Hall sensors 9 that are combined into a unit 8 and oriented with an offset of 90° from each other in order to detect the different switching positions of the actuating element 4, which can be acted upon by rotation and pulling.

The Hall sensors 9 are coupled to an electrical system of a motor vehicle by integrated strip conductors 10 and terminal contacts 11 in the base 6. Due to the arrangement of the Hall sensors 9 offset by 90°, on rotation of the actuating element 4, which is coupled by the axle 5 to the permanent magnet 7, a sine-like or cosine-like signal shape of the current is detected, as the magnetic field of the permanent magnet 7 is rotated from one pole to the other pole. Upon pull/push action on the actuating element 4, the permanent magnet 7 is also axially displaced and the amplitude of the signal shape is altered accordingly. As the signal shape can be defined unambiguously, evaluation of the position of the actuating element 4 is provided.

Furthermore, for positioning the actuating element 4, on the axle 5 are mounted latch bushes 12, 13 which co-operate with latch indentations 14 on the housing side, one latch bush 12 being used for fixing in the rotary switching positions and the other latch bush 13 for fixing in the pull switching positions. Furthermore, in the housing 1 are held optical fibres 15 with associated lighting elements for backlighting the symbols 3 which extend from the base 6 to the cover 2.

What is claimed is:

1. A rotary/pull switch having an actuating element comprising:
a base associated with a housing;
an axle having an associated permanent magnet, the axle guided in the housing and configured enable the permanent magnet to occupy a plurality of switching positions; and
a plurality of magnetic field sensors associated with the base and configured for determining the switching positions of the permanent magnet.

2. A rotary/pull switch according to claim 1, wherein the permanent magnet is arranged on an end of the axle facing towards the base.

3. A rotary/pull switch according to claim 1, wherein the magnetic field sensors comprise two Hall sensors offset from each other by 90°.

4. A rotary/pull switch according to claim 3, wherein the Hall sensors communicate with a control device by a bus system for evaluation of the detected signals.

5. A rotary/pull switch according to claim 3, wherein the bus system is a LIN bus.

6. A rotary/pull switch according to claim 1, wherein the Hall sensors are integrated with the base to form an assembly of moulded interconnected devices.

7. A rotary/pull switch according to claim 1, wherein the Hall sensors are associated with a printed circuit board within the housing.

8. A rotary/pull switch according to claim 1, wherein latch elements are arranged between the axle and the housing so as to affect the pull and rotary switching positions of the actuating element.

9. A rotary/pull switch according to claim 1, wherein at least one optical fibre is arranged within the housing, the optical fibre being associated with a light source for backlight symbols on the housing side.
